(19) United States
(12) Patent Application Publication
(10) Pub. No.: US 2023/0043396 A1
(43) Pub. Date: Feb. 9, 2023

(54) PET GROOMING TOOL

(71) Applicant: AARONCO PET PRODUCTS, INC., Somers, NY (US)

(72) Inventor: Samuel Kohl, Somers, NY (US)

(21) Appl. No.: 17/394,610

(22) Filed: Aug. 5, 2021

(51) Int. Cl. A01K 13/00

(52) U.S. Cl. CPC A01K 13/002

(57) ABSTRACT

A grooming tool for removing dead, shed hair from the coat of an animal such as a dog, has a blade, and a handle affixed thereto, with the blade having two separate rows of teeth along opposite edges thereof. A kit for removing shed hair from an animal's coat contains two of these grooming tools which in turn have different degrees of teeth along the respective rows to accommodate stripping shed hair of different texture.

### BACKGROUND OF THE INVENTION

The present invention is directed to a grooming tool for removing dead, shed hair from the coat of an animal such as a dog. More particularly, the present invention comprehensively improves removal of such shed hair in efficient manner, with minimal trauma to the animal.

Various grooming tools for removing dead hair that has been shed from the coat of an animal but still clings thereto, are well-known. Such dead hair is no longer attached to the hair follicles in the animal's body, but can still become entangled in the live coat of hair of the animal. All these previously-known blades have just a single row of teeth on each blade. Therefore, it was previously necessary to switch to different tools having differing degree of teeth to accommodate shed hair of different texture from the animal. For example, not all hair shed from a dog possesses the same texture, density, consistency, etc.

Typically, removing hair shed from the coat of an animal constitutes inconvenience during grooming, because a groomer must stop brushing the animal's coat and reach for the appropriate grooming tool having the required degree of teeth.

This has especially been a problem, because an animal's coat does not possess all uniform hair thickness and texture. For example, the head of most dogs has hair not as thick and dense as on other parts of the dog's body. Additionally, the hair coats of e.g., a Chihuahua and an old English sheepdog are naturally quite different and require different grooming tools, including those for removing dead hair that has been shed.

It has now been found removal of any dead, shed hair from the animal's coat can be expedited along with concomitant grooming of the animal with improved efficiency.

More particularly, it has now been found possible to expedite removing the dead shed hair off the animal with minimal inconvenience in having to slow down or stop other brushing and grooming. It is now possible to customize removing dead hair shed from different parts of an animal's body having different degree of density, thickness, length, etc., accelerating the overall grooming process which can often be time-consuming.

Accordingly, it is an object of the present invention to improve grooming of an animal such as dog, notably removing dead hair that has been shed from the animal's coat.

It is a more specific object of the present invention to improve efficiency and expedite removing dead hair that has been shed from the animal's coat to avoid stopping or interfering with other grooming such as brushing.

It is also an object of the present invention to customize removal of dead hair shed from an animal's coat having differing hair density, thickness, texture, etc., at various locations.

### SUMMARY OF THE INVENTION

These and other objects are attained by the present invention which is directed to a grooming tool especially designed for removing dead, shed hair from the coat of an animal such as a dog, and having a blade, and a handle affixed thereto. The blade has two separate rows of teeth along opposite edges thereof, preferably with different spacing, density and number of teeth from one another. The present invention is also directed to a grooming kit for removing dead, shed hair from the coat of an animal such as a dog, and having a pair of these grooming tools. In particular, one of the tools has a blade with opposite rows of teeth having spacing, density and number intermediate from spacing density and number of teeth in the rows on the other tool.

The grooming tool and kit according to the present invention improves efficiency and expedites removing dead hair shed from the coat of an animal which can interfere with and slow down overall grooming of the animal. It is no longer necessary to carry a whole series of cumbersome grooming tools for removing the dead hair shed of different texture from an animal's coat, but rather just a minimal number of such tools will suffice. Shed hair of different texture can be efficiently and quickly removed from different parts of the animal, e.g., the trunk, legs, head, etc. all shedding different texture of hair.

A special improvement is arranging just a pair of such grooming tools, e.g., within a carrying case to form a kit, with the degree of teeth along the edges of the grooming tools arranged such that one such grooming tool has rows of opposite teeth intermediate in degree between the rows of teeth on the other grooming tool. Therefore, one grooming tool has rows of teeth for removing coarse or extra fine shed hair, while the other tool has rows of teeth for removing medium or fine shed hair from the animal's coat. The maximumly effective removal of different texture of shed hair over the whole body of the animal is thereby attained in minimal time and with minimal inconvenience.

### BRIEF DESCRIPTION OF THE DRAWINGS

The present invention will be described in greater detail with reference to the accompanying drawings in which

FIG. 1 illustrates a perspective view of an opened kit containing the grooming tools according to the present invention,

FIG. 2 illustrates a top plan view of a first one of the grooming tools according to the present invention,

FIG. 3 illustrates a bottom plan view of the grooming tool of FIG. 2,

FIG. 4 illustrates a top plan view of a second one of the grooming tools according to the present invention,

FIG. 5 illustrates a bottom plan view of the grooming tool of FIG. 4,

FIG. 6 illustrates a side elevational view of the grooming tool shown in FIG. 2 in the direction of arrow L,

FIG. 7 illustrates a sectional view along line 7-7 in FIG. 2, and

FIG. 8 illustrates a sectional view along line 8-8 in FIG. 2.

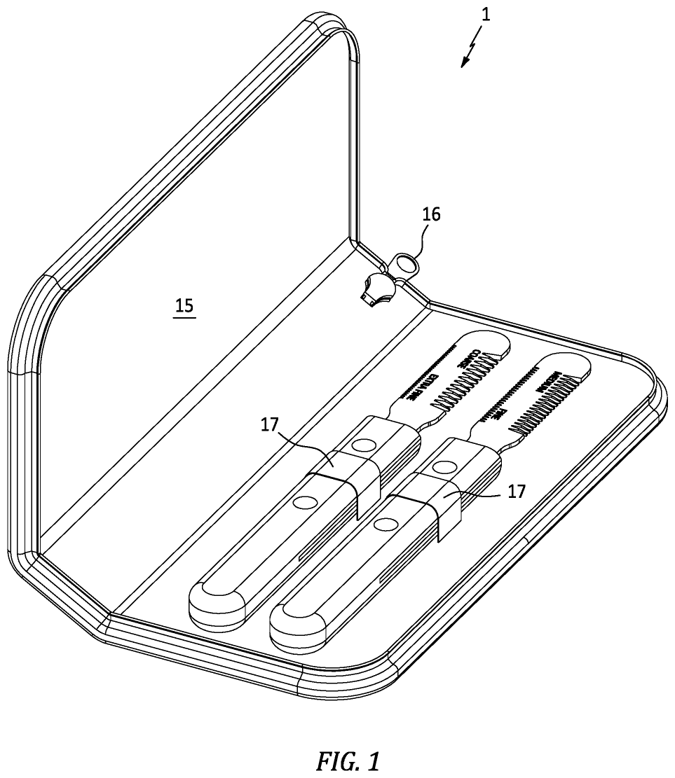

### DESCRIPTION OF THE PREFERRED EMBODIMENTS

As illustrated in the drawings, the present invention is directed to a kit 1 containing a pair of grooming tools 2, 3 for removing the dead hair shed from the animal's coat, with each tool 2, 3 having a blade 4, 4′ secured in a slot at a flat end 12 thereof within a handle 5, 5′ by non-removal metal bolts 10 (analogous components in grooming tool 3 are denoted by prime symbols). The blade 4, 4′ and bolts 10 are made of metal, e.g., stainless steel, while the handle 5,5′ is preferably formed from wood.

Opposite lateral edges of the exposed portion of the blade 4, 4′ contain rows of teeth for removing the dead hair shed from the animal, as the grooming tool 2, 3 is swept over the animal's coat, without disturbing the living hair growing from the hair follicles or irritating or hurting the animal. As shown, one surface of the row of teeth is flat, and the opposite surface of teeth is beveled or angled downwardly towards the flat surface. In particular, the respective rows of teeth are flat and angled on opposite surfaces from one another. Additionally, the exposed end 6, 6′ of the blade 4, 4′ opposite the handle 5, 5′ is blunted or rounded for safety, while the opposite end 11, 11′ of the handle 5, 5′ is also rounded.

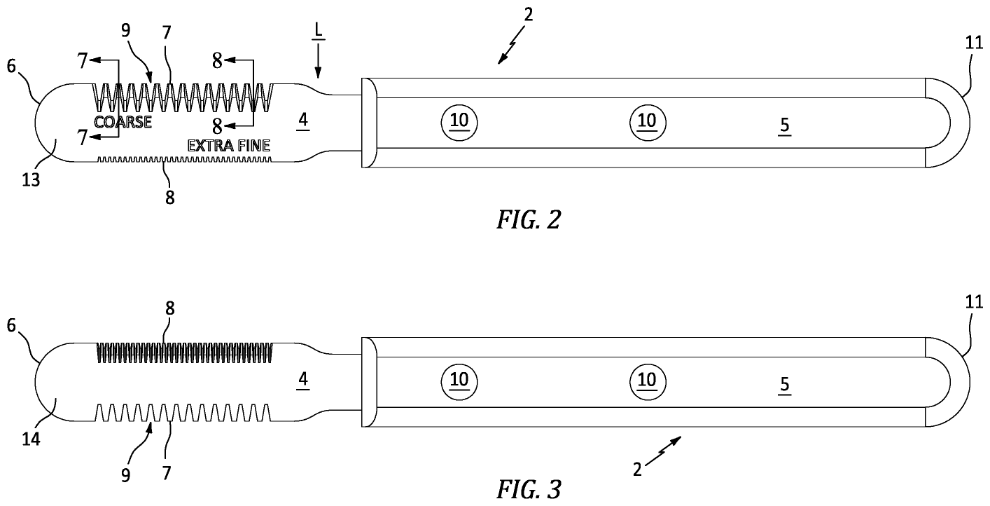

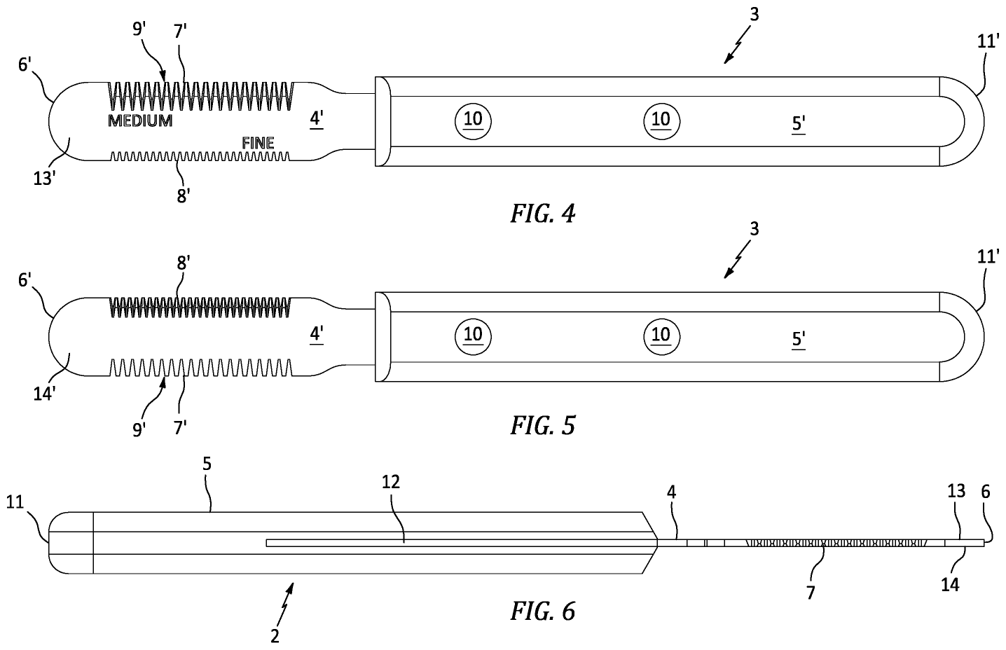

The teeth of each row form a point at an apex of an acute angle formed by sides of each tooth when viewed in the top and bottom views of FIGS. 2-5, with the teeth protruding over a longitudinally-extending edge along an opposite surface of the blade as illustrated, e.g., in the top views of FIGS. 2 and 4. The spacing 9 between the rows of teeth also slopes downwardly to the opposite surface, as illustrated in FIGS. 2 and 4. In particular, the opposite rows of teeth in each grooming tool have different spacing, density and number of teeth from one another.

More specifically, one of the tools 3 has a blade with rows of teeth 7′, 8′ having spacing, density and number intermediate from spacing density and number of teeth 7, 8 in the rows on the other tool 2. In other words, as shown in the drawings, one of the tools 2 has rows of teeth 7, 8 having largest spacing, lowest density and smallest number of teeth, or closest spacing, largest density and largest number of teeth respectively, while the other grooming tool 3 has rows of teeth 7′, 8′ having spacing, density and number of teeth closer in degree to one another.

As shown in FIG. 2, in grooming tool 2 which has rows of teeth 7, 8 for respectively removing coarse and extremely fine shed hair, one side 13 contains teeth 7 arranged for removing shed coarse hair and sloping towards the opposite flat side 14 (FIG. 3). At the same time, the teeth 8 arranged for removing extremely fine shed hair slope from the opposite side 14 towards the flat side 13 (FIG. 2) as shown in FIG. 3. Analogous arrangement of the rows of teeth 7′, 8′ for removing medium and fine shed hair appears on the other grooming tool 3 as shown in FIGS. 4 and 5.

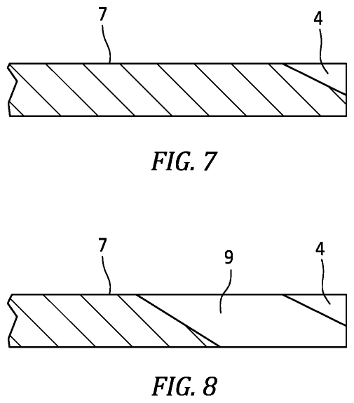

In the illustrated embodiment, thirteen teeth 7 appear in the coarse row and 33 teeth appear in the extra fine row in grooming tool 2, while eighteen teeth 7′ appear in the medium row and 26 teeth 8′ appear in the fine row in grooming tool 3. Furthermore, as shown in the sectional views of FIGS. 7 and 8, the angled surface of teeth 7 in the coarse row is beveled between the top flat “horizontal” surface and flat “vertical” edge. Teeth 8, 7′ and 8′ are similarly-beveled in the grooming tools 2 and 3.

The kit 1 for containing these grooming tools 2, 3 can include a double-hinged carrying case 15 which can be closed by a zipper 16. Elastic clips or loops 17 can retain the respective grooming tools 2, 3. The carrying case 15 can be made from, e.g., imitation leather.

Therefore, as shown in the drawings, one of the grooming tools 2 is capable of removing either coarse or extremely fine dead hair shed from the animal, while the other tool 2 is capable of removing medium or fine shed hair. Accordingly, it is possible to conveniently remove dead hair shed from an animal with just a minimal number of grooming tools to accommodate the whole range of texture of the shed hair. This is especially advantageous, since not all shed hair from an animal possesses similar texture. For example, the trunk of an animal's body tends to shed thicker hair, while the head and face shed extremely fine hair and the legs and tail often shed intermediate degrees of hair texture.

Only a minimal number of such grooming tools need be kept on hand, and with each tool containing rows of teeth of differing degrees for removing dead hair shed from the coat of an animal. The grooming tools can be incorporated into the kit 1 for the same as illustrated, and retained therein by the elastic clips or loops 17 which receive and retain the handles 5, 5′ of the respective grooming tools 2, 3.

The preceding description of the invention is merely exemplary and not intended to limit the scope thereof in any way.

What is claimed is:

1. A grooming tool for removing dead, shed hair from the coat of an animal such as a dog, comprising
a blade, and
a handle affixed to the blade,
wherein the blade comprises two separate rows of teeth along opposite edges thereof.

2. The tool of claim 1, wherein the opposite rows of teeth have different spacing, density and number of teeth from one another.

3. The tool of claim 1, wherein each row of teeth is flat along one side of the blade and angled from an opposite side of the blade.

4. The tool of claim 3, wherein teeth in each said row are beveled between a top flat surface and flat perpendicular edge.

5. The tool of claim 1, wherein said rows of teeth are flat and angled along opposite sides of the blade from one another.

6. The tool of claim 5, wherein teeth in each said row are beveled between a top flat surface and flat perpendicular edge.

7. The tool of claim 1, wherein said teeth of each said row form a point at an apex of an acute angle formed by sides of each said tooth.

8. The tool of claim 1, wherein said teeth of each said row protrude over a longitudinally-extending edge along an opposite side of said blade.

9. The tool of claim 1, wherein a flat end of said blade is secured in a slot of said handle at an end remote from said rows of teeth.

10. A grooming kit for removing dead, shed hair from the coat of an animal such as a dog, comprising a pair of grooming tools, with each said grooming tool comprising
a blade, and
a handle affixed to the blade,
wherein the blade comprises two separate rows of teeth along opposite edges thereof, and
a carrying case arranged to receive and secure both said grooming tools therein.

11. The kit of claim 10, wherein the opposite rows of teeth in each said tool have different spacing, density and number of teeth from one another, and
the spacing, density and number of teeth in each said row of both tools are different from one another.

12. The kit of claim 10, wherein one of said tools comprises a blade with rows of teeth having spacing, density and number intermediate from spacing density and number of teeth in the rows on said other tool,
such that said other tool has rows of teeth having largest spacing, lowest density and smallest number of teeth, and closest spacing, largest density and largest number of teeth respectively, and
said one tool has rows of teeth having spacing, density and number of teeth closer to one another on said one tool.

13. The kit of claim 10, additionally comprising
a pair of elastic clips or loops secured inside said carrying case and configured to receive and retain a handle of a respective tool.

14. The kit of claim 10, wherein each row of teeth is flat along one side of the blade and angled from an opposite side of the blade.

15. The kit of claim 14, wherein said rows of teeth are flat and angled along opposite sides of the blade from one another.

16. The kit of claim 15, wherein teeth in each said row are beveled between a top flat surface and flat perpendicular edge.

17. The tool of claim 16, wherein said teeth of each said row form a point at an apex of an acute angle formed by sides of each said tooth.

18. The tool of claim 17, wherein said teeth of each said row protrude over a longitudinally-extending edge along an opposite side of said blade.
